(19) United States
(12) Patent Application Publication
(10) Pub. No.: US 2005/0025077 A1
(43) Pub. Date: Feb. 3, 2005

(54) Reverse link rate control mechanism for QoS

(76) Inventors: Srinivasan Balasubramanian, San Diego, CA (US); Rath Vannithamby, San Diego, CA (US)

Correspondence Address: COATS & BENNETT, PLLC, P O BOX 5, RALEIGH, NC, 27602, US

(21) Appl. No.: 10/870,275

(22) Filed: Jun. 17, 2004

Related U.S. Application Data
(63) Continuation-in-part of application No. 10/755,104, filed on Jan. 9, 2004.
(60) Provisional application No. 60/479,014, filed on Jun. 17, 2003.
(60) Provisional application No. 60/486,938, filed on Jul. 14, 2003.

(51) Int. Cl. H04B 7/00

(52) U.S. Cl. 370/310; 370/328; 370/352

(57) ABSTRACT

A reverse link rate control method and apparatus provide first rate control commands as the primary rate control for general, ongoing control of the reverse link rates of one or more mobile stations. These first rate control commands comprise, for example, periodically transmitted common rate control commands that are generated as a function of reverse link loading and are used to control the reverse link rates of mobile stations whose service requirements currently do not require targeted reverse link rate control. The exemplary method and apparatus further provide second rate control commands on an as needed basis, that are sent to targeted ones of the mobile stations to meet the specific Quality-of-Service requirements at individual mobile stations, or groups of mobile stations. Supplemental rate control channels can be assigned and released dynamically to targeted mobile stations to provide supplemental rate control on an as-needed basis.

### RELATED APPLICATIONS

This application claims priority under 35 U.S.C. § 119(e) from the following U.S. provisional applications: Application Ser. No. 60/479,014 filed on Jun. 17, 2003 and Application Ser. No. 60/486,938 filed on Jul. 14, 2003. This application further claims priority under 35 U.S.C. § 120 from the U.S. patent application entitled, “Generalized Rate Control for a Wireless Communication Network,” filed on Jan. 9, 2004, and assigned application Ser. No. 10/755,104. All of these applications are expressly incorporated in their entireties by reference herein.

### BACKGROUND OF THE INVENTION

The present invention generally relates to controlling reverse link rates of mobile stations operating in wireless communication networks.

Current and evolving wireless communication networks provide digital channels that are configured using wide ranges of available data rates. For example, networks based on cdma2000 or Wideband CDMA (W-CDMA) standards, offer configurable data rate channels on both the forward and reverse links. While the particular application(s) being run by a given user might dictate minimum or maximum data rates, many types of communication are amenable to transmission over variable data rate channels.

For example, a given mobile station may be engaged in a potentially lengthy data transfer, such as transferring a file using File Transfer Protocol (FTP), or sending email with attachments, etc. While a higher data rate in such instances represents a user convenience, i.e., less time waiting for the transmission to complete, lower data rates can be used for such applications. A lower data rate might be preferable where, for example, there are more “preferred” users with data to send, or where a network loading condition is high.

In particular, the data rates of mobile stations operating within a given service area (sector) of a wireless network may have their individual or collective reverse link data rates controlled as a function of reverse link loading. Loading conditions may be expressed in terms of rise-over-thermal receiver noise measurements at the corresponding radio base station, or may be evaluated using other measures, such as the number of users connected, aggregate reverse link throughput, etc.

Regardless, conventional approaches to rate control typically offer the limited choices of assigning mobile stations to a common rate control channel, to a group rate control channel, or to per-mobile, dedicated rate control channels. Typically, the rate control mechanism adopted for a given mobile station, or for a given group of mobile stations, reflects a compromise between maintaining manageable levels of rate control signaling overhead on the sector's forward link, and maintaining the appropriate reverse link throughput at the various mobile station.

### SUMMARY OF THE INVENTION

The present invention comprises a method and apparatus providing reverse link rate control in a wireless communication network, wherein the network transmits fundamental rate control commands, such as common rate control commands, to one or more mobile stations, and further transmits supplemental rate control commands to particular ones of them, or to particular groups of them, on an as-needed basis. In this manner, the network can provide general rate control, e.g., common rate control, for given mobile stations on a continuous basis and, when needed, temporarily override or modify that rate control at particular mobile stations using supplemental rate control to meet Quality-of-Service requirements for particular mobile stations, or for particular groups of mobile stations.

Accordingly, an exemplary method of controlling reverse link rates of mobile stations in a wireless communication network comprises transmitting fundamental rate control commands to provide primary reverse link rate control for one or more mobile stations, e.g., common rate control commands, and transmitting supplemental rate control commands on an as-needed basis to targeted ones of the one or more mobile stations to override the primary reverse link rate control at the targeted mobile stations. With this method, common or shared rate control commands can be transmitted for a group of mobile stations, such as for all users in a given radio sector, on a continuous basis, and targeted rate control commands can be sent to particular ones of the users, or to particular groups of the users, on a discontinuous, as-needed basis.

The targeted rate control commands, for example, can be formulated as mobile-specific commands determined as a function of mobile-specific Quality-of-Service requirements. Of course, a given mobile station may be running multiple service instances, and the targeted, supplemental rate control commands can be generated to meet the service needs of particular service instances, or at least to ensure that the needs of the most demanding service instance are met.

In another exemplary embodiment of the present invention, a method of controlling reverse link rates of mobile stations in a wireless communication network comprises transmitting first rate control commands for general reverse link rate control of one or more mobile stations, and transmitting second rate control commands on an as needed basis for specific reverse link rate control of at least one of the one or more mobile stations, while continuing to transmit the first rate control commands. Transmitting the first rate control commands may comprise transmitting common rate control commands for a group of mobile stations, and transmitting second rate control commands may comprise temporarily transmitting specific rate control commands as needed to support particular Quality-of-Service needs at specific ones of the one or more mobile stations.

Accordingly, an exemplary base station system comprises one or more reverse link rate control circuits configured to generate first rate control commands for general reverse link rate control of one or more mobile stations, and generate second rate control commands on an as needed basis for specific reverse link rate control of at least one of the one or more mobile stations, while continuing to transmit the first rate control commands.

The exemplary base station system thus may comprise a radio base station configured to transmit first and second rate control commands, wherein the first rate control commands provide general or primary rate control for one or more mobile stations, and wherein the second rate control commands provide targeted rate control for individual mobile stations, or groups of mobile stations, according to the service needs of targeted mobile stations. The first commands may be transmitted on a first rate control channel, such as a sector or group-specific common rate control channel, and the second rate control commands can be transmitted on one or more second rate control channels as needed. Note that individualized second rate control commands can be formulated for each of one or more targeted mobile stations, or groups of mobile stations, and multiplexed or dedicated rate control channels can be used to provide each such mobile station or group with its corresponding second rate control commands.

Of course, the present invention is not limited to the above exemplary embodiments. Those skilled in the art will recognize additional features and advantages upon reading the following detailed description, and upon viewing the accompanying drawings.

### BRIEF DESCRIPTION OF THE DRAWINGS

FIG. 1 is a diagram of a wireless communication network configured according to one or more embodiments of the present invention.

FIG. 2 is a diagram of exemplary Radio Base Station and Base Station Controller details.

FIG. 3 is a diagram of exemplary fundamental (primary) and supplemental (secondary) rate control in accordance with the present invention.

FIG. 4 is a diagram of exemplary processing logic to provide mobile stations with secondary rate control on an as-needed basis.

FIG. 5 is a diagram of exemplary primary/secondary rate control channels and exemplary service requirement feedback information, as established between a base station and a mobile station in accordance with the present invention.

### DETAILED DESCRIPTION OF THE INVENTION

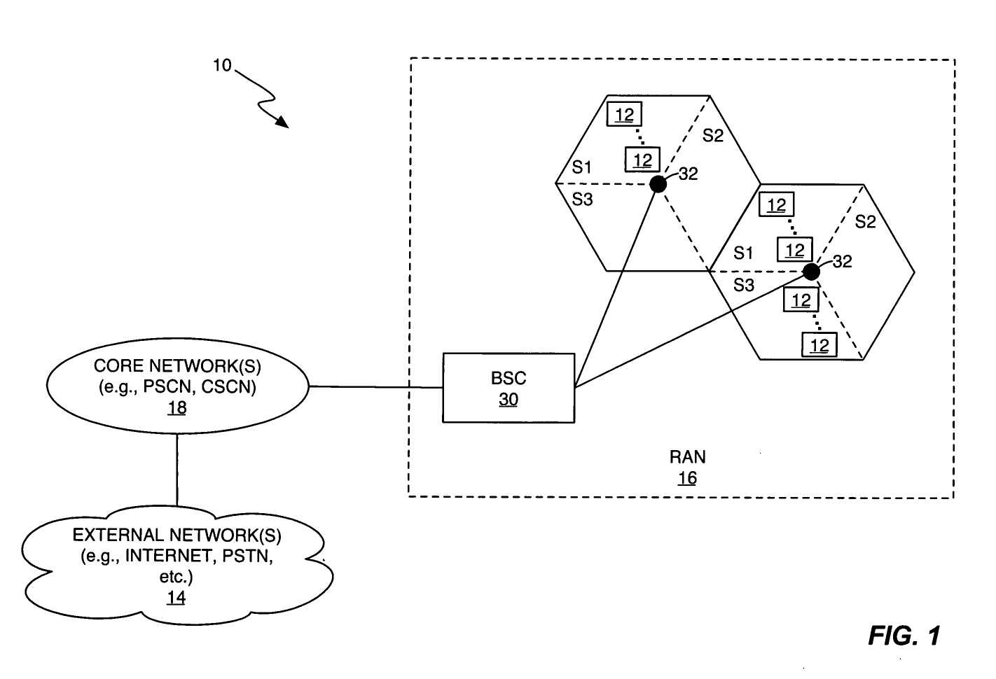

FIG. 1 illustrates an exemplary wireless communication network 10 that is configured to provide reverse link rate control according to the present invention. Network 10 is depicted in simplified form for purposes of discussion but those skilled in the art will appreciate that network 10 may include entities not illustrated, and that the illustrated entities may embody additional complexity. Further, it should be understood that while network 10 comprises a cdma2000 wireless communication network in one or more exemplary embodiments, the present invention is not so limited, and network 10 may be based on other standards, such as Wideband CDMA (WCDMA).

With the above in mind, network 10 communicatively couples mobile stations 12 to one or more external networks 14, such as the Internet or other Public Data Networks (PDNs) and/or the Public Switched Telephone Network (PSTN). In the exemplary, simplified illustration, network 10 comprises a Radio Access Network (RAN) 16 that is communicatively coupled to one or more Core Networks (CNs) 18, that in turn provide communication with the external networks 14. RAN 16 comprises one or more Base Station Systems (BSSs), each comprising a Base Station Controller (BSC) 30 and one or more associated Radio Base Stations (RBSs) 32. Those skilled in the art will appreciate other BSS arrangements are possible, e.g., BSC logic can be wholly or partially shifted to the RBS level, and the present invention contemplates all such variations.

In at least one embodiment, network 10 provides primary, continuous rate control to one or more mobile stations, and secondary, discontinuous rate control to one or more of those mobile stations as needed. Here, “continuous” simply connotes rate control commands that are generally sent on a repeating basis without extended interruption. “Discontinuous,” on the other hand, connotes rate control command transmissions that may be “bursty” in that they are transmitted to particular mobile stations only when needed to override or modify the primary rate control. Thus, the typical mobile station may rely on the general rate control provided by the primary rate control commands until its rate control needs require the use of mobile-specific, or group-specific rate control, in which case the mobile station temporarily may be assigned to a secondary rate control channel.

With such rate control in mind, one sees that each RBS 32 provides radio service over one, two, or more sectors—the illustrated RBSs 32 each provide coverage over three sectors, denoted as S1, S2, and S3. The term “sector” as used herein should be given broad construction and thus should be understood as meaning a defined radio coverage area. In an exemplary definition, the term sector denotes the intersection of a given radio carrier (frequency) with a given geographic coverage area. Thus, the illustrated RBSs 32 may use two or more radio carriers to provide overlaid sectors. In any case, such details are not central to understanding the present invention. Of relevance to the present invention, however, those skilled in the art should appreciate that the rate control method disclosed herein can be varied as needed within and between sectors.

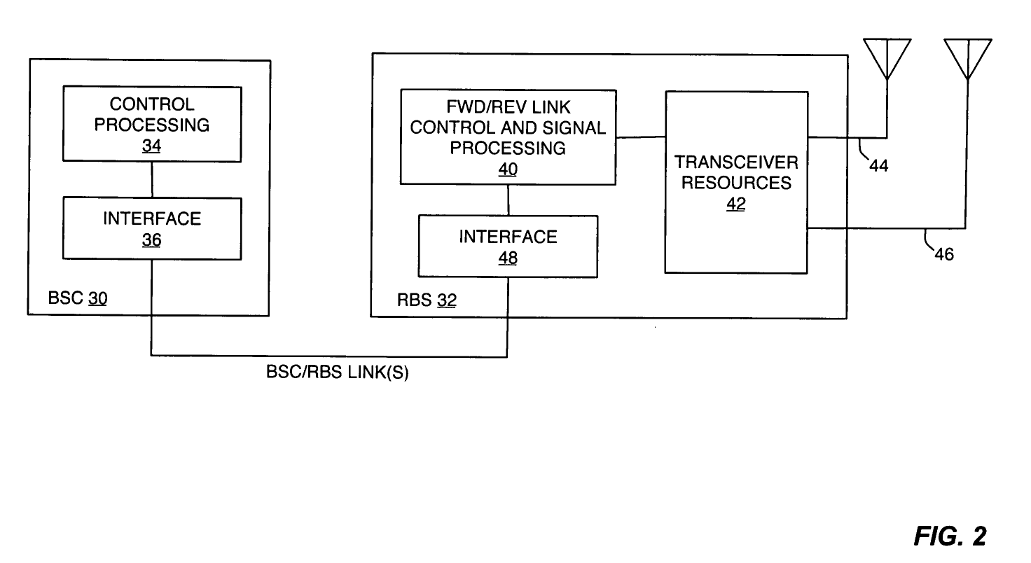

FIG. 2 illustrates an exemplary base station, or BSS, comprising a BSC 30 and a RBS 32, which are illustrated in terms of simplified function elements to aid clarity. It should be understood that BSC 30 generally is configured to support multiple RBSs 32, and that each RBS 32 can be configured to support multiple radio sectors.

In any case, BSC 30 comprises control processing circuits 34, e.g., one or more signal processors, microcontrollers, etc., configured to provide call control logic for setting up, maintaining, and tearing down logical connections associated with voice and/or data calls terminating at and originating from various ones of the mobile stations 12 being supported by RBS 32, and further comprises interface circuits 36 for communicatively coupling to RBS 32, e.g., backhaul interface circuits for E1/T1 lines, microwave, etc. Interface circuits 36 may include additional, possibly different interfaces for communicating with the CNs 18, such as for communicating with a Mobile Switching Center (not illustrated). Further, BSC 30 may include or be associated with a Packet Control Function (PCF), or like entity, providing a Radio-Packet (RP) interface between the packet side of the CNs 18 and the RAN 16.

RBS 32 comprises forward/reverse link control and signal processing circuits, which are referred to herein collectively as processing circuits 40. RBS 32 further comprises transceiver resources 42 and associated receive/transmit antenna elements 44 and 46, respectively, and one or more interface circuits 48 to communicatively couple RBS 32 to BSC 30. Exemplary processing circuits 40 comprise one or more signal processors, e.g., DSP circuits, microprocessors/microcontrollers, or the like, and associated supporting circuits, while the transceiver resources 42 comprise the modulation/demodulation and coding/decoding circuits used to implement the physical layer channels used to communicate with the mobile stations 12 on the forward (transmit) and reverse (receive) links.

In accordance with one or more embodiments of the present invention, exemplary rate control can be implemented by configuring hardware, software, or any combination thereof, at BSC 30 and/or at RBS 32. For example, processing circuits 40 at RBS 32, which as noted may comprise microprocessor resources, may be configured to provide exemplary primary and supplemental rate control according to the present invention. Further, at least some rate control processing can be supported by appropriately configuring processing circuits 34 at BSC 30. Such shared processing between the BSC and RBS may be particularly appropriate where BSC 30 processes or provides information used in rate control adjustments.

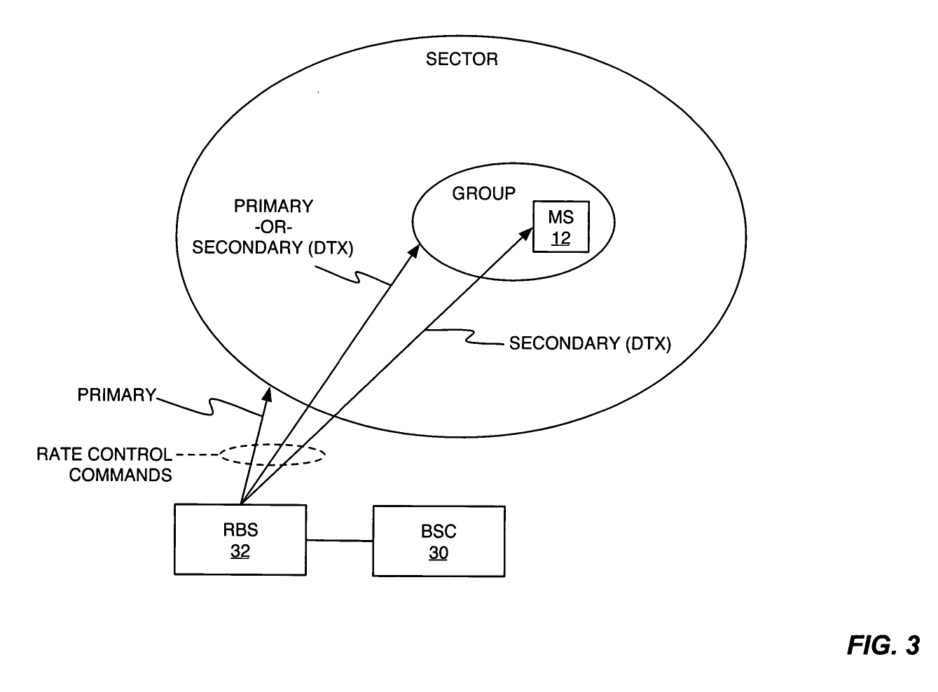

Regardless of such implementation details, FIG. 3 illustrates BSC 30 and RBS 32 in the context of providing primary and secondary reverse link rate control to a mobile station 12. Primary rate control commands also may be referred to herein as “fundamental” rate control commands, and secondary rate control commands also may be referred to herein as “supplemental” rate control commands.

The illustrated mobile station 12 may receive sector-wide rate control commands as its “primary” rate control commands, and may receive, on an as needed basis, group-specific rate control commands as its “secondary” rate control commands. As an alternative, mobile station 12 may receive group-specific rate control commands as its primary rate control commands, and may receive, on an as-needed basis, mobile-specific rate control commands as its secondary rate control commands. As a further alternative, mobile station 12 may receive sector-wide rate control commands as its primary rate control commands, and may receive, on an as-needed basis, mobile-specific rate control commands as its secondary rate control commands. Of course, other combinations of primary/secondary rate control are contemplated herein.

In looking at an example wherein the mobile station 12 receives sector-wide rate control commands as its primary reverse link rate control commands, it should be noted that these sector-wide rate control commands may be generated as a function of reverse-link loading for the sector in which mobile station 12 is operating. RBS 32 and/or BSC 30 can estimate sector loading by measuring the rise-over-thermal receiver noise at the base station's radio receivers. Alternative methods of measuring reverse link loading may be used, such as by determining aggregate throughput on the reverse link, monitoring the number and type of users, identifying whether a significant number of users in the sector are being underserved, etc.

Generally, if the reverse link loading condition is high relative to one or more measurement thresholds, which may be set relative to a base station “outage” probability, for example, the common rate control commands are generated as “down” commands, which cause the mobile stations 12 following those commands to incrementally adjust their rates downward. Conversely, if loading is light, the common rate control commands are generated as “up” commands, in which case the mobile stations 12 following those commands incrementally adjust their rates upward. In practice, the common rate control commands vary back and forth between up and down as a function of changing loading conditions.

Note, too, that the common rate control commands can be generated as “load indicators,” which may be referred to as “reverse activity bits.” According to that method of rate control command generation, the base station varies one or more transmitted common rate control command bits to reflect changing reverse link load conditions, and the mobile stations 12 are configured to process the load indicators accordingly. For example, mobile stations 12 can be programmed to increase their data rates—subject to radio condition and transmit power limitations—responsive to receiving indications of light reverse link loading, and to decrease their data rates—subject to service requirement restraints, etc.—responsive to receiving indications of heavy reverse link loading.

With primary and secondary rate control, the primary rate control commands can be used to “throttle” a group of users to a lower rate, or to maintain that group at the current rate(s), while secondary rate control commands are then used to control the data rates of specific ones of them as needed. For example, to allow particular ones of them to achieve high data rates according their specific QoS needs.

For example, support may be prioritized for particular users, or groups of users, e.g. gold/silver/bronze data users. Thus, the invention may comprise a sector control mechanism with configurable tables/functions to implement such prioritization, or a scheduling control algorithm may employ primary and secondary rate controls to prioritize users. In other scenarios, primary/secondary rate control may be used to support different QoS requirements for different service instances at a mobile station 12 having multiple service instances. Such a mobile station 12 can provide feedback to indicate the specific service instances that have reached high buffer levels, e.g., “watermark” levels. That data, along with the power headroom feedback, feedback, allows for relative prioritization amongst the various mobiles within a given sector.

Common to the above primary/secondary rate control variations, and others, RBS 32 and/or BSC 30 may be configured to provide mobile station 12 with first rate control commands that are transmitted on a continuous basis, such that mobile station 12 receives what may be regarded as “default” rate control commands to be followed in the absence of receiving any secondary, overriding commands. While they do not have to be shared, these default rate control commands preferably are shared by a number of mobile stations 12, whether by group, or by sector.

If the default rate control commands are not sufficient to meet the service requirements of a particular mobile station 12, secondary rate control commands are transmitted to it as needed. These secondary rate control commands thus provide a “bursty” rate control channel that may be used to override the default rate control at mobile station 12 on an as needed basis.

As will be explained below, the assignment of a supplemental rate control channel to mobile station 12 for transmission of secondary rate control commands can be triggered based on monitoring service requirements and/or feedback from the mobile station 12. For example, the mobile station 12 can be configured to provide buffer level feedback, in which case it transmits information to network 10 related to its reverse link transmission queue. Thus, an excessive length transmit queue at mobile station 12 can serve as a trigger for the assignment of a supplemental rate control channel, and secondary rate control channels can be sent to the mobile station 12 to allow it to achieve higher reverse link data rates than would be obtained via the default rate control commands.

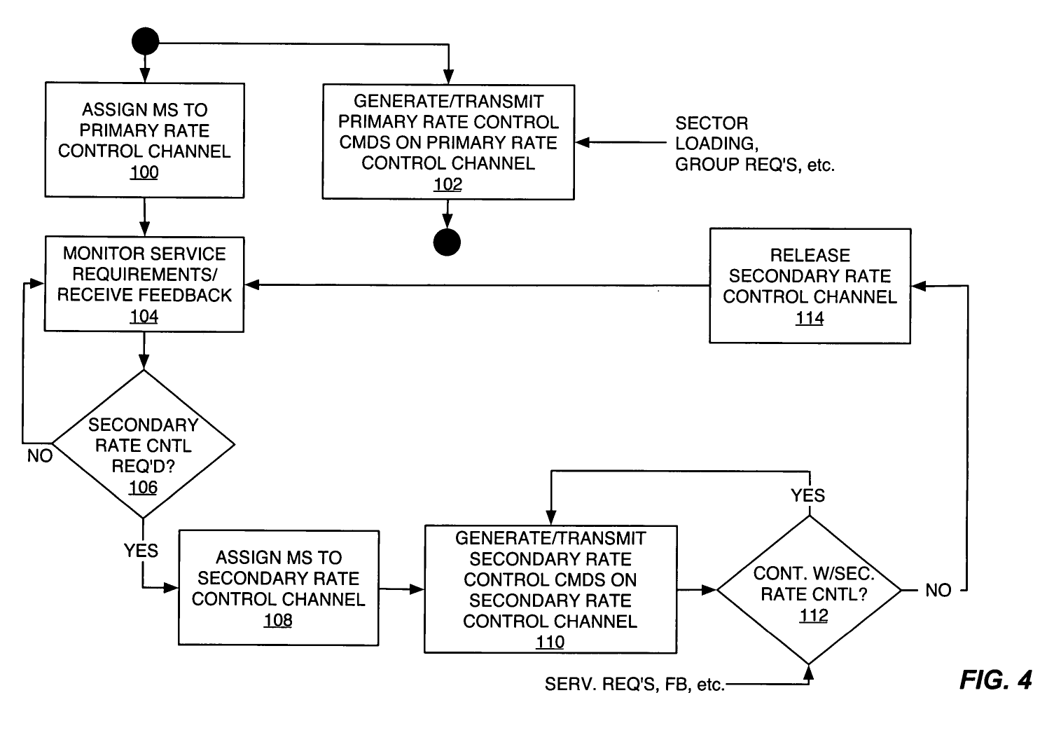

Of course, as explained later herein, other forms of feedback and service requirement monitoring can be used to trigger secondary rate control channel assignments to meet mobile-specific and group-specific service requirements (QoS) on an as needed basis. Regardless of the particular triggering mechanism(s) used, FIG. 4 illustrates exemplary processing logic for managing primary and secondary rate control channel assignments.

Processing “begins” with the assignment of a particular mobile station 12 to a primary rate control channel (Step 100). As noted, this primary channel preferably is a shared rate control channel, and thus may carry common rate control commands for the radio sector in which the mobile station 12 is operating, or may carry group-specific rate control commands for a given group to which the mobile station 12 is assigned. Note that group rate control may be used to provide differentiated services based on user class, e.g., Gold, Silver, Bronze, etc.

As described in detail the incorporated and co-pending application entitled, “Generalized Rate Control for a Wireless Communication Network” (Ser. No. 10/755,104), the primary rate control channel may be time multiplexed onto another channel. For example, in cdma2000-based networks, one or more Forward Common Rate Control Channels (F-CRCCHs) may be multiplexed onto the Forward Common Power Control Channel (F-CPCCH), which generally comprises multiplexed power control bits (PCBs) for power-controlling a corresponding plurality of mobile stations 12. For example, multiplexing rate control commands onto the power control channel can be based on replacing unused power control bits with rate control bits, or based on periodically puncturing one or more power control bits with rate control information.

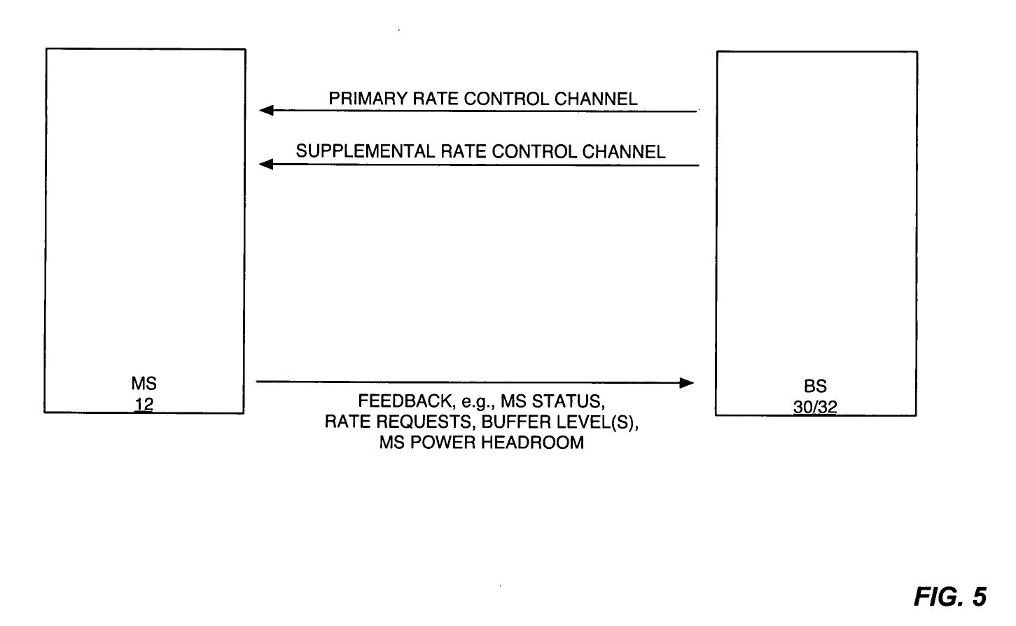

In any case, once the mobile station 12 has been assigned to a primary rate control channel, its ongoing service requirements are monitored to determine whether the primary rate control commands are sufficient to address the reverse link service requirements of the mobile station 12 (Step 104). FIG. 5 illustrates a number of mobile-station-to-base-station feedback mechanisms, one or more of which may be used in logically evaluating whether temporary assignment of a secondary rate control channel to the mobile station 12 is warranted. Such feedback includes but is not limited to status indicators, reverse link rate requests, transmit buffer queue information, and transmit power headroom information.

Status indications from the mobile station 12 may be used to indicate that the mobile station 12 needs to increase its reverse link data rate, while rate requests may be used by the mobile station 12 explicitly to request a reverse link rate change. Likewise, the transmit buffer queue information may be sent by mobile station 12 as an indication of whether the current reverse link throughput is sufficient for it. Here, the buffer level information may be quantized to save bits. For example, the empty-to-full buffer status continuum can be quantized using two or three bits, for example, to provide a multi-valued buffer level indicator to the base station. Alternatively, or additionally, the mobile station 12 may send transmit power headroom indications to the base station, where such information is useful in terms of deciding whether the mobile station 12 currently has enough reserve transmit power available to operate at a higher reverse link data rate.

Further, where the mobile station 12 is running multiple service instances, quantized buffer level information for any or all of the multiple service instances can be generated. The quantized buffer levels from multiple service instances can be sent in one report, or in successive reports, if desired.

Any and all such information thus can be used to evaluate whether temporary secondary rate control is required to meet the reverse link service requirements of the mobile station 12 (Step 106). If it is determined that secondary rate control is required, the mobile station 12 is assigned to a secondary rate control channel (Step 108), and supplemental rate control commands are then transmitted to the mobile station 12 on that secondary channel (Step 110). The secondary commands may be generated as a function of specific Quality-of-Service requirements for mobile station 12.

Once the secondary channel is assigned, service conditions/requirements may be monitored to determine whether and when the secondary rate control channel should be released (Step 112). For example, the secondary rate control channel may be maintained for the mobile station 12 for so long as its queue level is above a defined threshold, for so long as it continues requesting higher reverse link rates, etc. Of course, the logic used to maintain or release the secondary rate control channel can be further conditioned on higher-level considerations, such as overall reverse link loading, whether any other mobile stations 12, or groups of mobile stations 12, have a higher service priority, etc.

Once it is determined that secondary rate control no longer is needed (or desired) for the mobile station 12, the secondary rate control channel assignment is released (Step 114). Upon release of the secondary rate control channel, the mobile station 12 reverts to the reverse link rate control provided on the primary rate control channel. Note that where secondary rate control commands are being provided to a targeted group of mobile stations 12, the decision to release the secondary rate control command can be based on determining that none of the mobile stations 12 in the group any longer require the secondary rate control commands to meet their service needs.

It should be noted that the mobile stations 12 generally can be configured such that received secondary rate control commands completely override received primary rate control commands. That is, according to an exemplary embodiment of the above processing logic, the primary rate control commands are persistent, and continue to be received in addition to any secondary rate control commands that are being received. Thus, a given mobile station 12 can be configured exclusively to follow secondary rate control commands for so long as such commands are received, and to follow primary rate control commands only in the absence of secondary rate control. Alternatively, the mobile stations 12 can be configured to modify their responses to the primary rate control commands based on received secondary rate control commands, if any. In that latter approach, the effective rate control at a given mobile station 12 would thus comprise some logical combination of primary and secondary rate controls as provided on primary and secondary rate control channels.

Previous information herein noted that the primary and secondary rate control channels can be formed as multiplexed sub-channels on a common power control channel, for example. Thus, RBS 32/BSC 30 may transmit first (primary) rate control commands to be shared by a group of mobile stations 12 on a Forward Common Rate Control Fundamental Sub-Channel (F-CRCFSCH) defined on F-CPCCH.

Then, for each group of mobile stations 12, or for each specific mobile station 12, for which secondary rate control is needed, RBS 32/BSC 30 may transmit second (supplemental) rate control commands on corresponding Forward Common Rate Control Supplemental Sub-Channels (F-CRCSSCHs). These secondary rate control channels each carry second rate commands to their corresponding mobile stations 12, or to their corresponding groups of mobile stations 12, and they, too, may be multiplexed onto the common power control channel. Where multiple common power control channels are used, different primary-and-secondary rate controls may be carried on each of them, as needed.

Other channels also may be used to provide the inventive primary/secondary rate control. For example, RBS 32/BSC 30 may use a given Forward Grant Channel (F-GCH) to provide shared, primary rate control commands to a given group of mobile stations 12. Then, it may use any number of additional, second F-GCHs to provide secondary rate control commands to targeted ones of those mobile stations 12, or to targeted sub-groups of them. In this context, and in other contexts herein, it should be appreciated that rate control commands may comprise, but are not limited to, explicit rate grants, or incremental up/down commands. Further, it is not necessary that the primary and secondary rate control commands be of the same type. For example, the primary rate control commands for a given group can be an explicit grant, and the secondary rate control commands sent to a targeted member of that group can be generated as incremental up/down commands, or as explicit grant commands.

Regardless, those skilled in the art should appreciate that the present invention broadly addresses the need to meet bursty QoS requirements at targeted mobile stations 12 as needed through the temporary assignment of secondary rate controls, and that a variety of primary/secondary channel implementations may be used. Regardless, the present invention reduces signaling overhead by preferably limiting the transmission of supplemental rate control commands to those mobile stations 12 whose reverse link service requirements at least temporarily cannot be satisfied by the common rate control commands being transmitted.

As such, the present invention is not limited by the exemplary details presented in the foregoing, nor is it limited by the accompanying illustrations. Indeed, the present invention is limited only by the following claims and their reasonable legal equivalents.

1. A method of controlling reverse link rates of mobile stations in a wireless communication network comprising:
transmitting first rate control commands for general reverse link rate control of one or more mobile stations; and
transmitting second rate control commands on an as needed basis for specific reverse link rate control of at least one of the one or more mobile stations, while continuing to transmit the first rate control commands.

2. The method of claim 1, wherein transmitting first rate control commands comprises transmitting common rate control commands for a group of mobile stations.

3. The method of claim 2, wherein transmitting second rate control commands comprises temporarily transmitting specific rate control commands as needed to support particular Quality-of-Service needs at specific ones of the one or more mobile stations.

4. The method of claim 1, wherein transmitting first rate control comprises transmitting common rate control commands for a group of mobile stations, and wherein transmitting second rate control commands comprises transmitting mobile-specific rate control commands as needed to override the common rate control commands at selected ones in the group of mobile stations.

5. The method of claim 1, wherein transmitting first rate control commands comprises transmitting common rate control commands for a radio sector of the network as a function of reverse link load conditions.

6. The method of claim 5, wherein transmitting second rate control commands comprises transmitting, as needed, mobile-specific rate control commands for specific ones of the mobile stations in the radio sector as a function of mobile-specific service requirements.

7. The method of claim 5, wherein transmitting second rate control commands comprises transmitting, as needed, group-specific rate control commands for specific groups of the mobile stations in the radio sector as a function of group-specific service requirements.

8. The method of claim 1, wherein transmitting first rate control commands comprises transmitting incremental up/down rate control commands as a function of reverse link load conditions.

9. The method of claim 8, wherein transmitting second rate control commands comprises transmitting targeted rate control commands to one or more specific mobile stations as a function of service requirements associated with the one or more specific mobile stations.

10. The method of claim 9, wherein transmitting targeted rate control commands to one or more specific mobile stations as a function of service requirements associated with the one or more specific mobile stations comprises, for each targeted mobile station, transmitting mobile-specific rate control commands as a function of corresponding mobile-specific Quality of Service requirements.

11. The method of claim 1, wherein transmitting second rate control commands comprises, for one or more targeted mobile stations, transmitting targeted rate control commands as a function of Quality-of-Service feedback from the one or more targeted mobile stations.

12. The method of claim 11, wherein transmitting targeted rate control commands as a function of Quality-of-Service feedback from the one or more targeted mobile stations comprises receiving feedback from each targeted mobile station comprising at least one of reverse link status information, reverse link buffer level information, and reverse link power headroom information, and using said feedback to generate the targeted rate control commands for each targeted mobile station.

13. The method of claim 1, wherein the first rate control commands comprise fundamental rate control commands providing common reverse link rate control for mobile stations in a given radio sector of the network, and wherein the second rate control commands comprise supplemental rate control commands targeted to specific mobile stations in the given radio sector, and operative to override the common reverse link rate control at the specific mobile stations.

14. The method of claim 1, wherein transmitting first rate control commands comprises transmitting the first rate control commands on a fundamental rate control channel and transmitting second rate control commands comprises transmitting the second rate control commands on one or more supplemental rate control channels.

15. The method of claim 1, further comprising identifying specific mobile stations, or specific groups of mobile stations, as targets for specific reverse link rate control based on receiving Quality-of-Service feedback from the one or more mobile stations.

16. The method of claim 15, further dynamically updating which mobile stations are identified as requiring specific reverse link rate control responsive to changing Quality-of-Service feedback from the one or more mobile stations.

17. A base station system comprising one or more reverse link rate control circuits configured to:
generate first rate control commands for general reverse link rate control of one or more mobile stations; and
generate second rate control commands on an as needed basis for specific reverse link rate control of at least one of the one or more mobile stations, while continuing to transmit the first rate control commands.

18. The base station system of claim 17, wherein the one or more reverse link rate control circuits are configured to generate the first rate control commands as common rate control commands for a group of mobile stations.

19. The base station system of claim 18, wherein the one or more reverse link rate control circuits are configured to generate specific rate control commands as needed to support particular Quality-of-Service needs at specific ones of the one or more mobile stations.

20. The base station system of claim 17, wherein the one or more reverse link rate control circuits are configured to generate the first rate control commands as common rate control commands for a group of mobile stations, and to generate the second rate control commands as mobile-specific rate control commands to override the common rate control commands at selected ones in the group of mobile stations on an as-needed basis.

21. The base station system of claim 17, wherein the one or more reverse link rate control circuits are configured to generate the first rate control commands as common rate control commands for a radio sector of the network as a function of reverse link load conditions.

22. The base station system of claim 21, wherein the one or more reverse link rate control circuits are configured to generate the second rate control commands as mobile-specific rate control commands for specific ones of the mobile stations in the radio sector on an as-needed basis as a function of mobile-specific service requirements.

23. The base station system of claim 21, wherein the one or more reverse link rate control circuits are configured to generate the second rate control commands as group-specific rate control commands for specific groups of the mobile stations in the radio sector on an as-needed basis as a function of group-specific service requirements.

24. The base station system of claim 17, wherein the one or more reverse link rate control circuits are configured to generate the first rate control commands as incremental up/down rate control commands as a function of reverse link load conditions.

25. The base station system of claim 24, wherein the one or more reverse link rate control circuits are configured to generate the second rate control commands as targeted rate control commands to one or more specific mobile stations as a function of service requirements associated with the one or more specific mobile stations.

26. The base station system of claim 25, wherein the one or more reverse link rate control circuits are configured to generate the targeted rate control commands for each targeted mobile station based on generating mobile-specific rate control commands as a function of corresponding mobile-specific Quality of Service requirements.

27. The base station system of claim 17, wherein the one or more reverse link rate control circuits are configured to generate the second rate control commands for one or more targeted mobile stations by generating targeted rate control commands as a function of Quality-of-Service feedback from the one or more targeted mobile stations.

28. The base station system of claim 27, wherein the one or more reverse link rate control circuits are configured to generate the targeted rate control commands for each targeted mobile station based on corresponding received feedback comprising at least one of reverse link status information, reverse link buffer level information, and reverse link power headroom information.

29. The base station system of claim 17, wherein the one or more reverse link rate control circuits are configured to generate the first rate control commands as fundamental rate control commands providing common reverse link rate control for mobile stations in a given radio sector of the network, and to generate the second rate control commands as supplemental rate control commands targeted to specific mobile stations in the given radio sector, and operative to override the common reverse link rate control.

30. The base station system of claim 17, wherein the base station system is configured to transmit the first rate control commands on a fundamental rate control channel and to transmit the second rate control commands on one or more supplemental rate control channels.

31. The base station system of claim 17, wherein the base station system is configured to identify specific mobile stations, or specific groups of mobile stations, as targets for specific reverse link rate control based on receiving Quality-of-Service feedback from the one or more mobile stations.

32. The base station system of claim 31, wherein the base station system is configured to dynamically update which mobile stations are identified as requiring specific reverse link rate control responsive to changing Quality-of-Service feedback from the one or more mobile stations.

33. A method of controlling reverse link rates of mobile stations in a wireless communication network comprising:
transmitting fundamental rate control commands to provide primary reverse link rate control for one or more mobile stations; and
transmitting supplemental rate control commands on an as-needed basis to targeted ones of the one or more mobile stations to override the primary reverse link rate control at the targeted mobile stations.

34. The method of claim 33, wherein transmitting fundamental rate control commands comprises transmitting the fundamental rate control commands on a first grant channel.

35. The method of claim 34, wherein transmitting supplemental rate control commands comprises transmitting the supplemental rate control commands on a second grant channel.

36. The method of claim 33, wherein transmitting fundamental rate control commands comprises transmitting the fundamental rate control commands on a common rate control channel, and wherein transmitting supplemental rate control commands comprises transmitting the supplemental rate control commands on one or more supplemental rate control channels.

37. The method of claim 33, wherein transmitting supplemental rate control commands comprises transmitting mobile-specific rate control commands on an as needed-basis to the targeted mobile stations based on mobile-specific service requirements at each of the targeted mobile stations.

38. The method of claim 37, further comprising determining the mobile-specific rate control commands at least in part based on receiving Quality-of-Service feedback from the targeted mobile stations.

39. The method of claim 37, further comprising dynamically determining the targeted mobile stations based on receiving Quality-of-Service feedback from the one or more mobile stations, and identifying which of them requires supplemental reverse link rate control.
